(19) United States
(12) Patent Application Publication
(10) Pub. No.: US 2024/0305405 A1
(43) Pub. Date: Sep. 12, 2024

(54) TRANSCEIVER AND OPERATING METHOD

(71) Applicant: Fraunhofer-Gesellschaft zur Förderung der angewandten Forschung e.V., München (DE)

(72) Inventors: Jürgen HUPP, Erlangen (DE); Oliver HAALA, Erlangen (DE); Tobias DRÄGER, Erlangen (DE); Josef BERNHARD, Erlangen (DE)

(21) Appl. No.: 18/599,635

(22) Filed: Mar. 8, 2024

(30) Foreign Application Priority Data
Mar. 10, 2023 (DE) 10 2023 202 208.7
Aug. 11, 2023 (DE) 10 2023 207 765.5

(51) Int. Cl. H04L 1/00; H04B 1/7143; H04W 28/04

(52) U.S. Cl. CPC H04L 1/004; H04B 1/7143; H04W 28/04

(57) ABSTRACT

Transceiver configured to transmit at least one source packet in split and coded form, having: a splitter configured to divide the at least one source packet into several source segments; an encoder configured to encode the several source segments by coding rule in order to obtain coded segments; a transmitter configured to transmit the coded segments as PHY packets by means of a plurality of cycles each having a plurality of subcycles, each subcycle having several slots; wherein the coding rule specifies transfer of the plurality of source segments by means of forward error correction, and wherein the coding rule specifies an order such that a coding degree of the coded segments transmitted in the last PHY packet is reduced or reduced to coding degree 1.

### CROSS-REFERENCE TO RELATED APPLICATIONS

This application claims priority from German Application No. 102023207765.5, which was filed on Aug. 11, 2023, and from German Application No. 102023202208.7, which was filed on Mar. 10, 2023, which are both incorporated herein by reference in their entirety.

### TECHNICAL FIELD

Embodiments of the present invention relate to a transceiver, e.g. a transceiver for being uses as a sensor and/or actuator node or master node. One embodiment relates to a transceiver as a transmitter, another embodiment relates to a further transceiver as a receiver and to the corresponding methods and computer-implemented methods. In general, the invention is in the field of deterministic data transmission using cycles and subcycles in combination with encoders.

### BACKGROUND OF THE INVENTION

One representative of deterministic data transmission is IO link wireless, which allows wireless data transmission with W cycles and W subcycles. IO link wireless defines 5 parallel tracks, each having up to 8 slots and several devices. This means that up to 40 devices or 20 devices in DSlots can be used. A W cycle, for example, has a length of approx. 5 ms and is divided into 3 W subcycles. For example, 1 downlink slot and up to 8 uplink slots are available per W subcycle. IO link wireless also uses frequency hopping, i.e. the frequency ranges shift from W subcycle to W subcycle, wherein different frequencies are also used for each W subcycle. These are referred to as W-tracks (definition according to IOLW Spec: W-Track: “physically wireless transmission track comprising a (small band) transceiver with its own antenna and dedicated frequency channels for transmitting the messages between W-Master and W-Device by W-Frames”).

To provide sufficient reliability, IO link wireless relies on a process based on ARQ with ACK and NACK, for example. ACK (acknowledgment) and NACK (non-acknowledgment) result in delays since the sender first has to wait for the response in order to react to the response (NACK or ACK). Starting from the fixed access time, this results in delays and also in a reduction in the data rate due to the elapsed cycle time until re-transmission. Therefore, there is need for an improved approach.

The object underlying the present invention is providing a concept for deterministic transmission which offers an improved compromise between transmission rate and reliability as well as latency.

### SUMMARY

According to an embodiment, a transceiver configured to transmit at least one source packet in split and coded form may have: a splitter configured to divide the at least one source packet into several source segments; an encoder configured to encode the several source segments by coding rule in order to obtain coded segments; a transmitter configured to transmit the coded segments as PHY packets by means of a plurality of cycles each having a plurality of subcycles, each subcycle having several slots; wherein the coding rule specifies transfer of the plurality of source segments by means of forward error correction, and wherein the coding rule specifies an order such that a coding degree of the coded segments transmitted in the last PHY packet is reduced or reduced to coding degree 1.

Another embodiment may have a sensor and/or actuator node having an inventive transceiver as mentioned above, configured to transmit coded segments as an uplink in an uplink area of the respective subcycle assigned to the node.

Another embodiment may have a master node having an inventive transceiver as mentioned above, configured to receive coded segments from the uplink and/or to transmit a packet in downlink.

According to another embodiment, a further transceiver configured to receive at least one source packet which is split and coded may have: a receiver configured to receive several PHY packets, each PHY packet having a coded segment and being transmitted by means of a plurality of cycles each having a plurality of subcycles, each subcycle having several slots; a decoder configured to decode the coded segments in order to obtain source segments; a combiner configured to assemble the source segments to form at least one source packet; wherein the decoder is configured to perform decoding as soon as a number k of coded segments has been received, wherein the number k corresponds to at least a number n of the source segments.

According to another embodiment, a method of operating an inventive transceiver as mentioned above may have the step of: transmitting, in a split and coded form, at least one source packet, having the following substeps: dividing the at least one source packet into a plurality of source segments; encoding the plurality of source segments by coding rule to obtain coded segments; transmitting the coded segments as PHY packets by means of several cycles each having several subcycles, each subcycle having several slots; wherein the coding rule specifies transferring the plurality of source segments by means of forward error correction, and wherein the coding rule specifies an order such that a coding degree of the coded segments transmitted in the last PHY packet is reduced or reduced to coding degree 1.

According to another embodiment, a method of operating an inventive further transceiver as mentioned above may have the steps of: receiving several PHY packets, each PHY packet having a coded segment and being transmitted by means of a plurality of cycles each having a plurality of subcycles, each subcycle having several slots; decoding the coded segments to obtain source segments; assembling the source segments to form at least one source packet; wherein decoding takes place as soon as a number k of coded segments has been received, wherein the number k corresponds to at least a number n of the source segments.

Another embodiment may have a non-transitory digital storage medium having a computer program stored thereon to perform a method of operating an inventive transceiver as mentioned above having the step of: transmitting, in a split and coded form, at least one source packet, having the following substeps: dividing the at least one source packet into a plurality of source segments; encoding the plurality of source segments by coding rule to obtain coded segments; transmitting the coded segments as PHY packets by means of several cycles each having several subcycles, each subcycle having several slots; wherein the coding rule specifies transferring the plurality of source segments by means of forward error correction, and wherein the coding rule specifies an order such that a coding degree of the coded segments transmitted in the last PHY packet is reduced or reduced to coding degree 1, when the computer program is run by a computer.

Another embodiment may have a-transitory digital storage medium having a computer program stored thereon to perform a method of operating an inventive further transceiver as mentioned above having the steps of: receiving several PHY packets, each PHY packet having a coded segment and being transmitted by means of a plurality of cycles each having a plurality of subcycles, each subcycle having several slots; decoding the coded segments to obtain source segments; assembling the source segments to form at least one source packet; wherein decoding takes place as soon as a number k of coded segments has been received, wherein the number k corresponds to at least a number n of the source segments, when the computer program is run by a computer.

Embodiments of the present invention provide a transceiver configured to transmit at least one source packet in split and coded form. For this purpose, the transceiver comprises a splitter, an encoder and a transmitter. The splitter is configured to divide the at least one source packet into several source segments. The encoder is configured to encode the several source segments by coding rule in order to obtain coded segments. The transmitter is configured to transmit the coded segments as

PHY packets (physical packets) by means of a plurality of cycles, each having a plurality of subcycles, each subcycle having several slots. The coding rule specifies transfer of the plurality of source segments by means of forward error correction, wherein an order is also predetermined such that a coding degree of the coded segments transmitted in the last PHY packet is reduced, e.g. to coding degree 1. According to embodiments, the coding rule may additionally specify the order such that a coding degree of the coded segments transmitted in the first PHY packet is reduced, e.g. reduced to 1.

Embodiments of the present invention are based on the finding that, in deterministic transmission methods, the several slots are used to transmit several PHY packets, each PHY packet having several source segments, i.e. parts of the source packet, in coded form. This allows the same number of source segments to be transmitted in fewer PHY packets, wherein coded source segments are also transmitted in the slots otherwise used, but not further ones, but those used for re-transmission, i.e. for forward error correction. In this respect, coding is used to increase the degree of redundancy in order to achieve increased reliability while maintaining at least the same data rate. Advantageously, the last PHY packet to be transmitted is used to transmit a coded segment in which the coding degree is reduced, e.g. reduced to 1. This has the advantage that the coding complexity decreases towards the end of the transmission and thus the decoding effort is reduced. This advantageously reduces the latency.

According to embodiments, according to the forward error correction, a source segment is contained in at least two coded segments or at least two PHY packets. For example, the coded segments are linearly independent, i.e. they form a linearly independent set. According to embodiments, the coding is performed according to a coding matrix which specifies the coding degree 1 at least for the last and/or the first segment. On closer inspection, the coding matrix according to embodiments can be described such that the coding matrix can be decomposed into n×n submatrices and/or can be decomposed into n×n invertible submatrices. The aspect with the submatrices has the technical effect that, for example, individual coded segments can be decoded by a submatrix, which creates the prerequisite for step-by-step decoding. The steps correspond to the number of coded segments received. According to embodiments, a number k of coded segments is sufficient for decoding the source segments if the number k is greater than or equal to a number n of source segments.

With regard to transmission, it is to be noted that, according to embodiments, the plurality of cycles can each comprise at least a first and a second subcycle, which are transmitted at different frequencies or even simultaneously at different frequencies. According to embodiments, one or more PHY packets are transmitted per subcycle. For example, one or more PHY packets can also be transmitted per subcycle at different frequencies. Both for the transmission of several PHY packets and for the transmission of several subcycles, the different frequencies can be defined by a frequency hopping pattern. The frequency hopping pattern can extend or be defined over several cycles and/or per cycle, i.e. for example, over several subcycles and/or per subcycle, i.e. for example, over several slots. According to embodiments, the frequency hopping pattern is predefined and known to the transceiver having transmit functionality, but also to the transceiver having receive functionality.

According to embodiments, it would be conceivable for the PHY packets to be transmitted over several slots or over several slots of the same frequency. According to further embodiments, several PHY packets can also be transmitted in one subcycle.

According to embodiments, a first source segment of the several source segments is transmitted in the first subcycle of the first cycle in accordance with the coding rule, wherein a second source segment of the several source segments is transmitted in the second subcycle of the first cycle in accordance with the coding rule. For example, a combination of the first source segment and the second source segment can be transmitted or repeatedly transmitted as a coded segment in a second or subsequent subcycle of the first cycle or in a subcycle of the second cycle. According to embodiments, the coding rule also defines a weighting factor.

According to embodiments, an area for a control command, in particular for channel code control commands, can be provided in each cycle and/or in each subcycle. Signaling of the transmission of the coded segments using the first subcycle and/or of the coded segments using a further subcycle takes place in an area for the control commands, in particular an empty field in the area for the control commands. According to embodiments, the signaling of the transmission of the coded segments in the first subcycle and/or of the coded segments in a further subcycle can take place via a checksum, such as a CRC value or CRC-32 value. Here, the signaling of the transmission of the coded segments in the first subcycle and/or of further coded segments can take place via a checksum of a respective subcycle or of an area of a subcycle defined for a specific transmission, e.g. at the end of the respective subcycle. According to embodiments, the checksum/CRC value/CRC-32 value is combined/convolved with an ID of the initial transmitter by means of a logical function, in particular an XOR function. The transceiver is configured to activate a flow control depending on the signaling in a standard mode or an extended mode for transmitting the coded segments.

According to embodiments, one or more downlink packets or multicast downlink packets can be transmitted in each subcycle. According to further embodiments, it is also possible to transmit one or more or a maximum of 8 uplink packets in each subcycle, i.e. also in the subcycles with the downlink packets. In the above embodiments, a deterministic transmission method was assumed. For example, the deterministic length or maximum length can be approx. 5 ms per cycle or a maximum of approx. 10 ms or a maximum of approx. 20 ms. According to embodiments, the transceiver is configured to operate according to the IO link standard or the IO link wireless standard.

A further embodiment provides a sensor or actuator node comprising a transceiver configured to transmit coded segments as uplink segments in an uplink area of the respective subcycle assigned to the node. According to a further embodiment, the transceiver can also be part of a master node configured to receive coded segments from the uplink and/or transmit packets in the downlink.

A further embodiment provides a further transceiver configured to receive at least one source packet which is split and coded. The further transceiver comprises a receiver, a decoder and a combiner. The receiver is configured to receive several PHY packets, each PHY packet having a coded segment and being transmitted by means of a plurality of cycles each having a plurality of subcycles. Each subcycle has several slots. The decoder is configured to decode the coded segments in order to obtain source segments. The combiner is configured to assemble the source segments to form at least one source packet. With regard to the decoder, it should be noted that it is configured to perform decoding as soon as a number k of coded segments has been received, wherein the number k corresponds to at least a number n of source segments (i.e. k≥n). According to embodiments, the decoder uses a coding matrix and/or submatrices derived from the coding matrix for decoding. The advantage of the derived submatrices is that individual coded segments can be decoded directly and decoding is also possible without all coded segments being received. As already explained above, a number k≥n of coded segments which are received is sufficient. The decoder is configured to retain the coding matrix or the submatrices (or the inverted matrices) for decoding. For example, it calculates the inverse matrices or submatrices in advance for each reception case and retains them. The number of submatrices or inverse matrices to be retained or used can be systematically reduced, namely as the number of received and/or non-received PHY packets increases. Depending on whether a PHY packet is successfully or unsuccessfully received, the matrices which are already to be used can be retained or the submatrices which are no longer to be used can be discarded. For example, the reduction is performed by excluding submatrices which are assigned to a specific PHY packet if the specific PHY packet is not received. Alternatively, the submatrix associated with a particular PHY packet is used if the particular PHY packet is received. According to embodiments, as reception progresses, the decoder may already perform partial decoding based on already received coded packets using the retained and/or the retained reduced submatrices. According to embodiments, this takes place step by step during reception, i.e. from slot to slot.

Another embodiment provides a method for operating a transceiver (transmit case). The method comprises the following steps:
transferring at least one source packet in split and coded form,
dividing the at least one source packet into a plurality of source segments,
encoding the plurality of source segments by coding rule to obtain coded segments,
transmitting the coded segments as PHY packets using several cycles, each having several subcycles, wherein each subcycle has several slots.

Again, the coding rule specifies transfer of the plurality of source segments by means of forward error correction together with an order (order so that the coding degree in the last PHY packet is reduced (coding degree 1)).

A further embodiment provides a method for operating a transceiver (receive case). The method comprises the following steps:
receiving several PHY packets, wherein each PHY packet comprises a coded segment and is transmitted by means of a plurality of cycles each having a plurality of subcycles, each subcycle having several slots,
decoding the coded segments to obtain source segments,
assembling the source segments to form at least one source packet.

Decoding takes place as soon as a number k of coded segments has been received, wherein the number k corresponds to at least a number n of source segments. According to further embodiments, the method may be computer-implemented.

### BRIEF DESCRIPTION OF THE DRAWINGS

Embodiments of the present invention will be explained referring to the accompanying drawings, in which:

FIG. 1a is a schematic block diagram of a transceiver according to a basic embodiment;

FIG. 1b is a schematic diagram of the processing and transmission chain to illustrate segmentation and coding according to embodiments;

FIGS. 2a-c are schematic diagrams for illustrating deterministic transfers in cycles and subcycles according to embodiments;

FIGS. 3a and 3b are schematic diagrams of cycles and subcycles to explain the processing time during transfer and decoding;

FIGS. 4a and 4b are schematic diagrams to explain formation of a coding matrix according to embodiments;

FIG. 5 is a schematic diagram for illustrating a decoding strategy according to embodiments;

FIG. 6 is a schematic diagram of an IO link wireless stack to illustrate an exemplary application example;

FIGS. 7a and 7b are schematic tables to explain network coding for IO link wireless as an application example;

FIGS. 8a and 8b are schematic diagrams to explain network coding as an application example for IO link wireless in a detailed view.

### DETAILED DESCRIPTION OF THE INVENTION

Before embodiments of the present invention will be explained below with reference to the accompanying drawings, it is to be noted that elements and structures having the same effect are provided with same reference numerals so that the description thereof is mutually applicable or interchangeable.

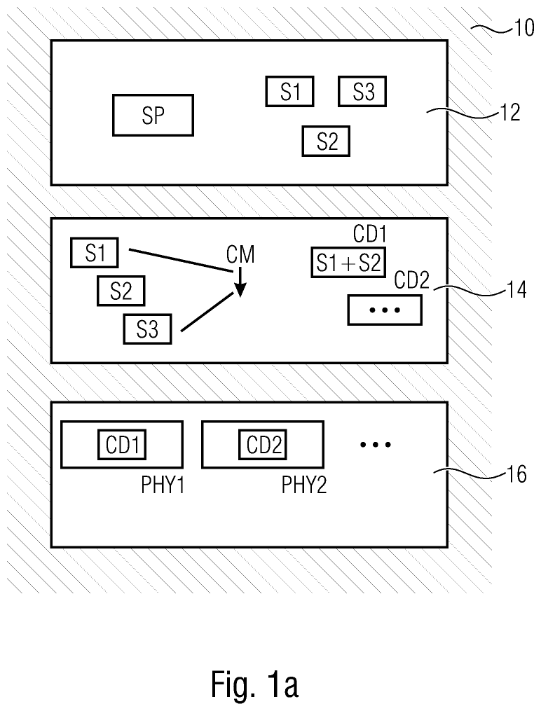

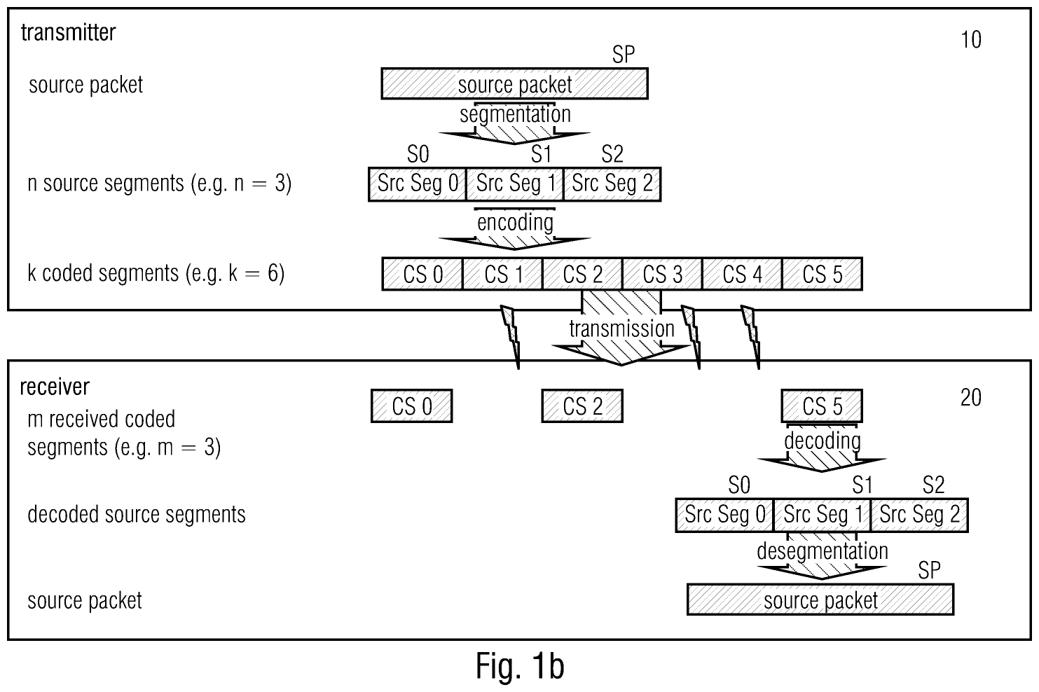

FIG. 1a shows a transceiver 10 having a splitter 12, an encoder 14 and a transmitter 16.

The transmit case of the transceiver 10 is explained below. The transceiver 10 contains a source packet SP which is divided into several source segments S1, S2, S3 by the splitter 12. These source segments S1, S2 and S3 are then made available to the encoder 14. The encoder 14 encodes the source segments S1, S2 and S3 to coded segments CD1, CD2, etc. in accordance with a coding rule CM. For example, the coded segment CD1 and CD2 can represent a combination of S1 and S2. The coding vector specifies how the segments are combined with each other, for example via a corresponding coding vector. The weighting of the individual coded segments S1 and S2, for example, is specified in this coding vector.

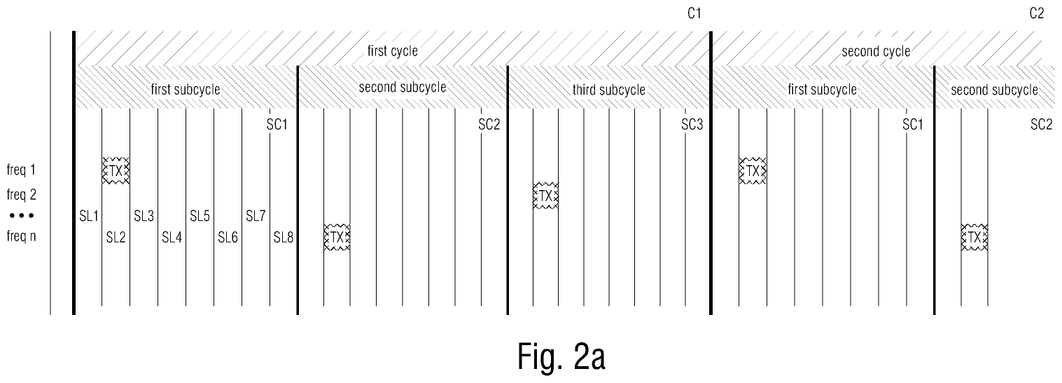

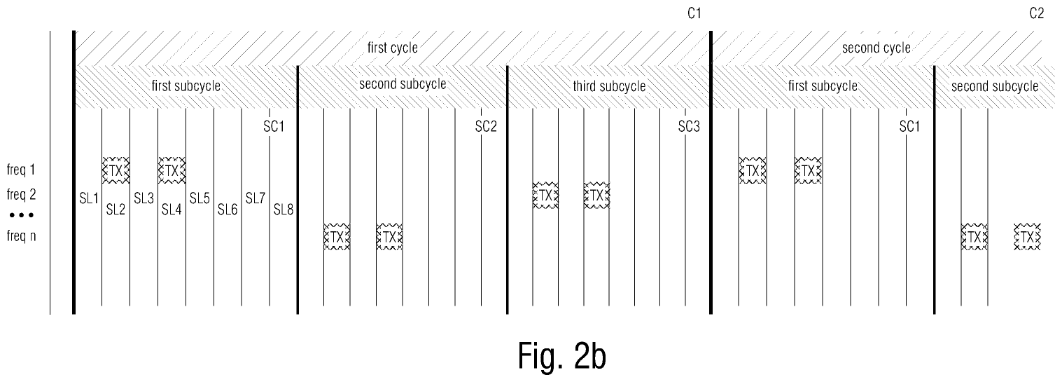

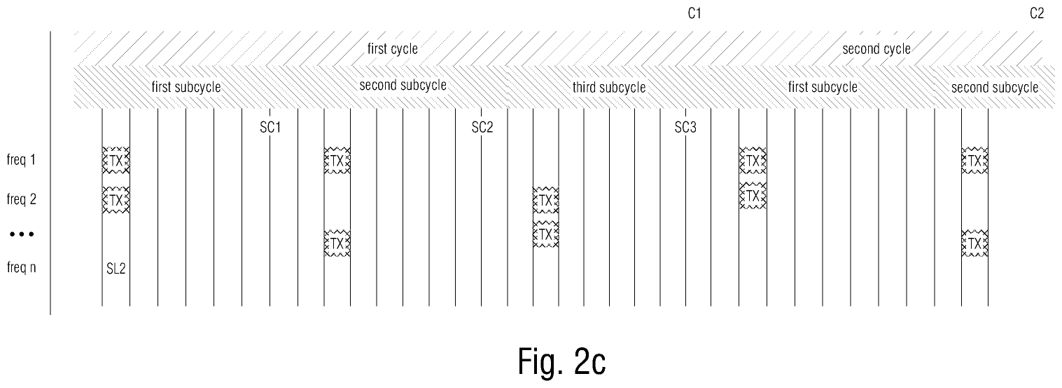

The transmitter 16 is configured to transfer the coded segments as PHY packets PHY1, PHY2, etc. by means of a plurality of cycles. In detail, the transmission takes place using a deterministic system, namely such that each cycle comprises a plurality of subcycles, several slots being provided in each subcycle. For example, each PHY packet is transmitted in one slot or in successive slots. This is discussed in connection with FIGS. 2a-c.

Before the structuring into cycles, subcycles and slots is discussed and the coding rule is explained, the segmentation, coding and transmission just explained are explained both from the transmitter 10 view and from the receiver 20 view, in connection with FIG. 1b.

FIG. 1b shows a transmitter 10 in which the source packet SP is segmented into the three source segments S0, S1, S2. The n source segments (n=3) are then coded and coded into the coded segments CS0-CS5 (k=6). Then, transfer to the receiver 20 is performed by the transmitter 10.

It receives the coded segments CS0-CS5 via a corresponding receiver. These coded segments, in this case CS0, CS2 and CS5, are fed to the decoder and decoded and then desegmented in order to obtain the source packet SP5 again. The content of the source packet on the receiver side 20 is identical to that of the source packet on the transmitter side 10, even if the transfer of the coded segments CS1, CS3 and CS4 is disturbed. In this case, the number of m received coded segments is smaller than the number of transmitted segments k (m=3, k=6).

According to embodiments, the coding rule CM specifies that individual source segments are transmitted repeatedly, namely with a so-called forward error correction (FEC). The consequence is that several source segments S0, S1 and S2 are contained at several points in the data stream, namely in coded form. For example, C0 can include the source segment S0, CS1 the combination of S0 and S1, CS2 the combination of S1 and S2, and CS5 S2 alone. This means that all source packets S0-S2 are contained in the transmitted coded segments CS0, CS2 and CS2, even if some coded segments have only been transmitted with disturbance or have not been transmitted. In other words, the forward error correction inserts redundancies into the coded data stream (coding=addition (e.g. XOR) of the source segments multiplied by coefficients, using arithmetics) so that the transfer reliability is increased. The number of PHY packets to be transferred is not increased or-in other words-the number of available slots is used, as will be explained in connection with FIGS. 2a, 2b and 2c. As a result, the data rate remains the same or can be increased depending on the coding degree.

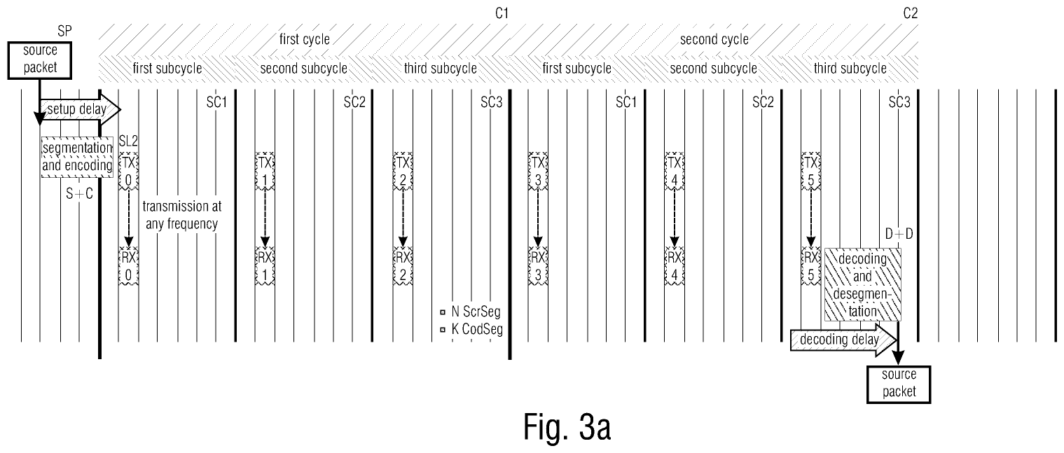

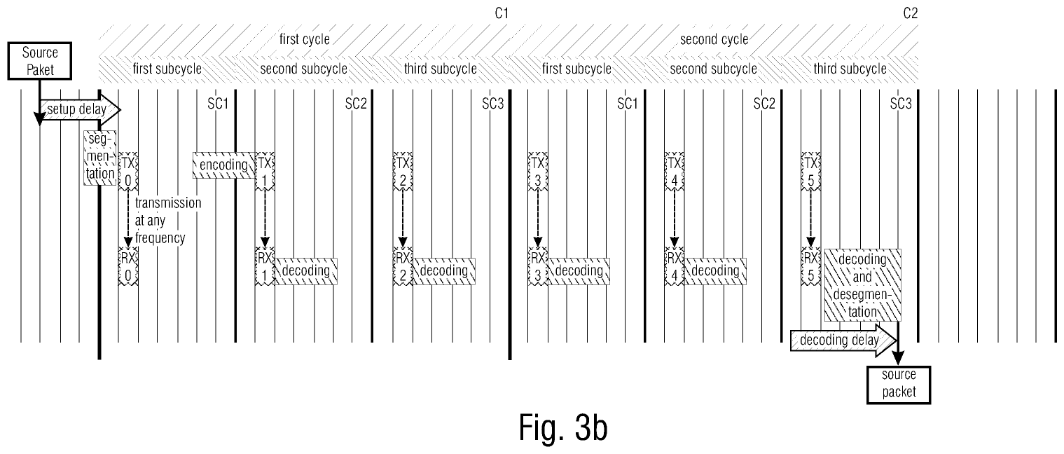

A detail will be discussed in advance, which will be explained in connection with FIGS. 3a and 3b. According to embodiments, the last coded segment, here CS5, has a reduced coding degree, such as coding degree 1. The background to this is that the decoding effort is reduced from the time the last coded segment CS5 is received, which ensures fast decoding. Coding degree 1 means that the last coded segment CS5 contains a source segment without coding so that all previous coded segments can be clearly resolved from the time of receiving the coded segment CS5. Another advantage of this procedure is that decoding can be started at an earlier point in time, e.g. after receiving CS2, which, as briefly mentioned above, contains the source segment S1 and S2, for example, while CS0 contains the source segment S0. This means that, in principle, all source segments are available, wherein receiving the third coded segment CS5 enables unambiguously decoding the linearly independent incoming data. As a result of the decoding, the source packets S0, S1 and S2 are then available, which can then be assembled by a further unit, i.e. the combiner, to form the source packet SP.

According to embodiments, the coded segments CS0-CS5 are transmitted between the transmitter 10 and the transceiver 20 using the following deterministic transmission method. Transmission takes place in cycles C1, C2, with each cycle C1, C2 having several subcycles, such as SC1, SC2 and SC3 (see FIG. 2a).

FIG. 2a shows the cycles C1 and C2 with the respective subcycles SC1, SC2 and SC3, which in turn are subdivided into slots SL1-SL8. This structure represents a deterministic transmission structure, wherein the length of the respective slot is predetermined, for example (with 5 ms or 10 ms). Different frequencies Freq1, Freq2, Freqn can be used in each subcycle SC1, SC2, SC3 or for each slot SL1-SL8.

In the transmission shown in FIG. 2, it is assumed that the first PHY packet PHY1, which contains the coded segment CS0, is transmitted in subcycle SC1, the second PHY packet with the coded segment CS1 in subcycle SC2, and the third PHY packet with CS2 in subcycle SC3. The further coded segments CS3 are then transferred in subcycles SC1, SC2, etc. of cycle C2. It is to be pointed out here that, according to embodiments, slot SL2 is assigned to transmitter 10, for example, i.e. fixedly for all subcycles SC1, SC2, SC3 of cycles C1 and C2. It is to be pointed out here that this procedure makes it possible, for example, for different subslots to be provided for different transmitters, e.g. 7 of the subslots for downlink and 1 of the subslots for uplink. By transmitting the different subcycles SC1, SC2 and SC3 in a slot assigned to a transmitter at different frequencies according to embodiments, transmission reliability can be increased advantageously since systematic disturbance in the individual frequency ranges can be excluded. In this respect, the individual subcycles SC1, SC2 and SC3 can follow a frequency hopping pattern in the respective cycle. It is to be pointed out here that frequency hopping can of course also take place within a subslot, e.g. if several transmitters use this subslot or, alternatively, if one transmitter, such as transmitter 10, uses several subslots per subcycle SC1/SC2/SC3. This approach is explained with reference to FIG. 2b.

FIG. 2b shows a transmission pattern with again two cycles, CS1 and CS2, wherein each cycle has three subcycles SC1, SC2 and SC3. Each subcycle in turn comprises 8 slots SL1-SL8. In this example, slots SL2 and SL4 are used for the transmission of PHY packets (see (TX)). This means that the transmitter 10 of FIG. 1 uses more than one slot to transmit the PHY packets. For example, the coded segment CS1 and CS2 is transmitted in the first subcycle SC1, while the packets CS2 and CS3 are transmitted in the second subcycle SC2. The individual transmissions (by means of PHY packets) are marked with TX. In this variation, the same frequencies are always used for each subcycle, although this can also be different according to embodiments, as will be explained in connection with FIG. 2c. It is to be noted at this point that, according to further embodiments, a PHY packet can also extend over several slots, e.g. slot SL2 and SL3.

FIG. 2c shows a transmission pattern with the cycles C1 and C2, each having the subcycles SC1-SC3. Each subcycle in turn has a plurality of slots SL1, etc. In this embodiment, slot SL2 is used to transmit 2 PHY packets, namely at 2 different frequencies (see TX).

According to embodiments, a combination, e.g. of the transmission variations of FIGS. 2b and 2c, would also be possible so that, for example, 4 PHY packets can be transmitted. According to further embodiments, a combination would also be conceivable such that a PHY packet is transmitted in a first slot SL2, while another PHY packet is transmitted in a second slot SL4, but in a different frequency range.

In summary, deterministic transmission can be defined as follows: Cyclic transmission takes place in cycles. User data are available as source packets, wherein the source packets are to be transmitted in one or more cycles. The cycle time for the user can be derived from this in accordance with embodiments. Dividing takes place within a cycle. For example, a cycle consists of one or more subcycles. A subcycle consists of one or more slots, for example. The PHY packet is transmitted in one or more slots (long PHY packet). According to embodiments, several frequencies are available for transmitting a PHY packet. One or more PHY packets can be transmitted per subcycle, and several frequencies can be used here. Transmission rules exist to determine the frequency used for a PHY packet. For example, frequency hopping can be used, where one frequency is used for all slots per subcycle and is changed in the next subcycle. Depending on the PHY packet size and the signaling, there is a maximum amount of data which can be transmitted in a PHY packet. According to embodiments, a longer source packet can be broken down into source segments according to the maximum amount of data which can be transmitted per PHY packet, which are then transmitted as PHY packets. In other words, according to embodiments, the segmentation is performed depending on the maximum amount of data to be transmitted and the number of available slots, subcycles and cycles.

Even if it was always assumed in the above embodiments that 2 or more cycles with 3 subcycles each are used, it would of course also be possible, for example, for 2 subcycles or even more than 3 subcycles to be used per cycle. According to embodiments, the number of slots per subcycle can also be different from 8 (more or less than 8). Typically, the structuring of resource portions (chronologically in cycles, subcycles and slots) is carried out by the communication standard used. One communication standard which uses such deterministic transmission times is IO link wireless. Of course, other transmission standards with different times per slot are also possible. All the above transmission variations according to FIGS. 2a, 2b and 2c have in common that forward error correction is possible according to the approach explained in connection with FIGS. 1 and 2. The transmission rate is increased by increasing the number of slots used per subcycle. Depending on the coding pattern, the retransmissions can take place immediately from the first transmission in the first subcycle or starting at a later subcycle. As already explained above, the coding rule is selected such that the last transmission, i.e. the last PHY packet used to transmit a source segment, is sent with a reduced coding degree, namely coding degree 1. The background to this procedure will be discussed with reference to FIGS. 3a and 3b.

FIG. 3a starts from the transmission method of the PHY packets in slot 2 of the respective subcycles SC1, SC2 and SC3 using cycles C1 and C2, as explained in connection with FIG. 2. Before transmission, the source packet SP is segmented into n source segments (e.g. n=3) so that k coded segments can be generated and transmitted using 6 PHY packets (see TX0-TX5). The receiver receives the source packet SP in order to transfer it in a segmented and coded way by means of the packets TX0, TX1, TX2, TX3, TX4 and TX5 in the subcycles SC1-SC3 of the cycle CS1-CS2. The respective transfer resources are marked with TX0-TX5. As can be seen, there is a certain delay between receiving the source packet SP and emitting the first PHY packet TX0, which is used for segmentation and coding on the one hand and for setup on the other hand. The time window for segmentation and coding or the resulting delay is marked with the reference numeral S+C.

Transfer takes place again in the second slot SL2 of the respective subcycle SC1-SC3. The PHY packets RX0-RX5 are then received in the same slot. As can be seen, any frequency can be used. Decoding the segmented and coded source packet SP2 also entails a certain amount of time, which is shown by the reference numeral D+D. This time is also known as decoding delay. By reducing the decoding degree in the PHY packet TX5, the duration for decoding and desegmentation D+D, i.e. the decoding delay for obtaining the source packet, can be reduced.

The reduction in processing time for D+D is shown in FIG. 3b. It is particularly important to reduce the decoding degree of the last transmitted coded packet, as this is significant for the expected time until the source packet is received. The decoding degree For the transmission of the PHY packets by means of steps RX1, RX2, RX3 and RX4 is less relevant as there is sufficient time available here due to the fact that packet RX6 is still to be expected.

According to further embodiments, the decoding degree of the first PHY packet, in this case TX0, can also be reduced, e.g. to coding degree 1, so that the first packet does not need to be coded at all and is transmitted directly after segmentation by means of the first PHY packet. This reduces the delay time S between receiving the source packet SP and transmitting TX0. The coding work can then take place after segmentation in the time window before TX1. This means that, according to embodiments, a reduced decoding degree of the last coded packet is also accompanied by a reduced coding degree of the first source packet. For example, the decoding degree can be 1, which would be interpreted as being equivalent to an undecoded transmission according to embodiments.

In summary, it can therefore be stated that the first transmitted coded segment can be degree 1 and therefore corresponds to a source packet, which leads to a reduction in the setup delay. Coding therefore takes place at a relaxed time before the second coded segment is transmitted. At least the last coded segment also has coding degree 1, which reduces the decoding effort after receiving the last coded segment. According to embodiments, the penultimate coded segment can also have a reduced coding degree so that, for example, the coded segments to be transmitted in the middle have an increased coding degree. When a second coded segment is received (after RX1 at the earliest), decoding processing can take place.

Coding with forward error correction which is optimized in terms of coding effort and decoding effort can be achieved by the coding matrix. The coding rule is represented by a coding matrix, which can have the following properties according to embodiments: at least the first and the last coded segment are degree 1 during transmission. The receipt of any m=n coded segments is sufficient for complete decodability, wherein n represents the number of source segments, i.e. each subset with n different coded segments from the k generated coded segments is linearly independent. This results in N linearly independent equations.

According to embodiments, the coding matrix can be decomposable or invertible into n×n matrices. To generate a set of coded segments with these properties, a finite body with a sufficient number of elements is to be selected.

There are different strategies for decoding according to embodiments. According to a first variation, a Gaussian elimination method can be used.

According to another variation, two-stage data processing can be used in regular operation, which is time-critical, instead of the Gaussian elimination method.

In the first stage, which takes place before regular operation, all receive cases which allow complete decoding are identified. An inverted matrix is calculated for each of these receive cases. This allows decoding with little effort. These inverse matrices (also known as submatrices) are stored or generally retained on the receiver node.

In a second stage, which takes place during regular operation, partial decoding takes place before the last coded segment is scheduled to be received. For this purpose, coded segments which have already been received are used to perform pre-processing with the inverse matrices still in question. At which or after which receive process the partial decoding is started is a design decision on which the processing effort, the transmission effort and the time behavior depend. According to an embodiment, the number of partial matrices in question can be reduced depending on the coded segments already received or not received. The background to this is that, depending on what has already been received or what has not already been received but could already be received, it becomes clear which submatrices can be used and which cannot be used and can therefore be discarded.

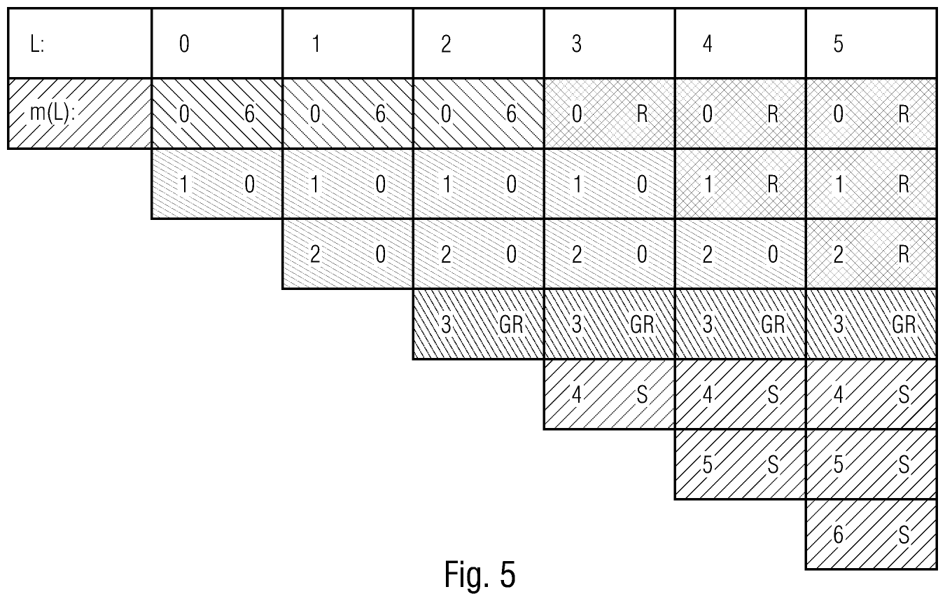

FIG. 5 illustrates the decoding strategy. In this example, n=3 and k=6 are assumed. The receive processes are numbered from 0-5 in columns L. These are essentially the same as the received packets RX0-RX5 or the transferred coded segments CS0-CS5. The number of correctly received coded segments at the end of the receive process L is symbolized by m(L). Fields marked with R illustrate the processes for which complete decoding is not possible. The background to this is that the number of correctly received packets is smaller than the number of source packets. If it is determined during the penultimate but one receive process that this packet is not received, it is no longer possible to correctly receive at least 3 coded segments corresponding to n=3.

Before complete decoding is not possible, decoding or even partial decoding may be possible, even if no packet has been received yet. These receive processes or non-receive processes are marked with the reference symbol G. As soon as a sufficient number of coded packets have not been received, the status changes from G to R. As long as no receive process has been successful, neither complete nor partial decoding can take place.

The fields for which partial decoding is already possible are marked with the reference symbol O, although complete decoding is not yet possible. As the receive process progresses and further coded segments are not received, decoding may not be possible if, for example, not enough coded segments are received. If, for example, one of the first segments, e.g. belonging to receive process 0, 1, 2 or 3, was received correctly, but the penultimate segment was not, it can also be determined that the number of correctly received packets N will always be smaller than n. This is the case for the penultimate packet with 1 received coded segment and for the last packet with 2 successfully received coded segments. In this case, the state always changes to R. Complete decoding is possible from N=3 received segments. These situations are marked with the reference symbol GR. This is possible at the earliest after receive process 2. For the sake of completeness, reference should also be made to the marked situation S. This is an overdetermined equation system, i.e. more coded segments are received than are used. In practice, this has no relevance due to energy efficiency.

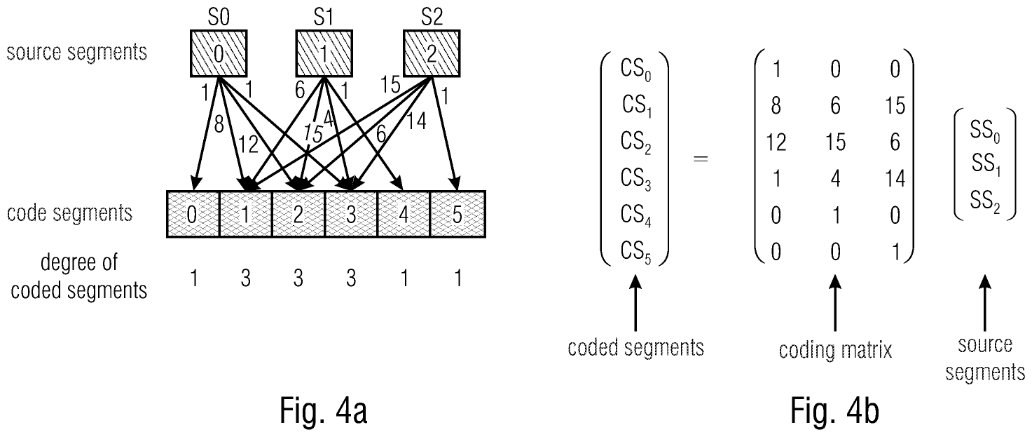

The coding of 3 source segments S0, S1 and S2 into 5 coded segments CS0-CS5 is explained below with reference to FIGS. 4a and 4b. FIG. 4a shows the 3 source segments S0-S2. These source segments S0-S2 are coded as coded segments CS0-CS5. Coding involves the addition of the source segments multiplied by coefficients using arithmetic in finite bodies. The addition can be realized as a logical XOR operation. CS1, CS2 and CS3 are coding degree 3, while CS0, CS5 and CS6 are coding degree 1. The background to this is that the coded segments are distributed as follows: S0 is distributed to CS1, CS2, CS3 and CS4, S1 is included in the coded segments CS1, CS2, CS3 and CS4. S2 is contained in the coded segments CS1-CS5. This means that the packets CS0, CS4 and CS5 each have only one source segment. The corresponding coding matrix is shown in FIG. 4b. The coded segments result from the convolution of the coding matrix with the source segment.

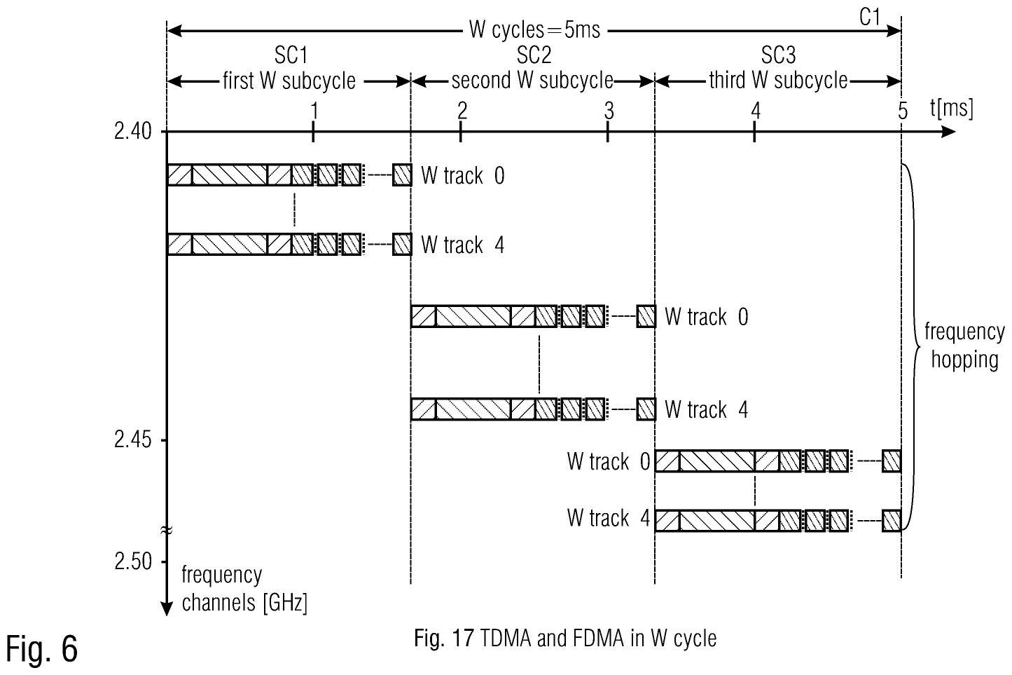

With reference to FIG. 6, a deterministic transmission method is now presented in which structuring into cycles and subcycles is possible. This is IO link wireless, with W cycles and W subcycles. For consistency, the same reference numerals are again used, even if it is a cycle or W cycle. The coded segments are transferred in the W tracks as PHY packets. W track 0 and W track 4 are available here for the first W subcycle SC1. The same W track 0 and W track 4 are also available in the second subcycle SC2 and SC3, but at different frequencies. The IO link wireless transmission method used here can be defined such that 5 parallel tracks with up to 8 subslots each are available for the devices. This means that up to 40 devices or 20 devices with DSlots can be used. The W cycles have 5 ms, divided into 3 W subcycles. One downlink slot and up to 8 uplink slots are used per W subcycle.

As a result, this means that the concept can be used for IO link wireless. In a wireless communication system with a deterministic cycle time, such as IO link wireless, forward error correction is used instead of ARQ. Systematic coding is used to generate m coded packets from n source segments, wherein the coded packets form a linearly independent set, i.e. n coded packets are sufficient to decode the n source segments. The transmission order of the coded packets is selected such that the decoding effort after receiving the last coded segment is minimized in order to keep the delay time after receiving the last coded packet low.

According to embodiments, downlink can represent a multicast, i.e. several packets are transmitted to possibly several devices in summed up form. The data packets for devices are secured via a CRC32 or generally a CRC at the end of the subcycle.

The uplink can be unicast, i.e. each device transmits its own slot. Security is again provided via CRC or CRC32. According to embodiments, it is conceivable for a final XOR to be sent. For example, the CRC or CRC32 is linked to the unique ID of the device, e.g. by using it as a seed for the CRC calculation or, after the CRC calculation, the unique ID by an XOR operation. According to embodiments, this XOR field or CRC field can be used to symbolize whether coded segments are contained and how these coded segments are contained. According to embodiments, signaling can also be performed using a different mechanism, e.g. using a control octet or also using bits in the channel code (ChC). There are reserved bits in the channel code which can be used in relation to the application. Flow control (FC) can also be used in combination with embodiments. With regard to the IO link wireless application, it is to be noted that several segments can also be used to transmit one or more coded segments in accordance with embodiments. The content of the signaling for transmitting a data packet (of any length) (source packet) can comprise one or more of the following elements:
data: data length of the source packet
coding rate, ⅓, ½, ⅔, for example.

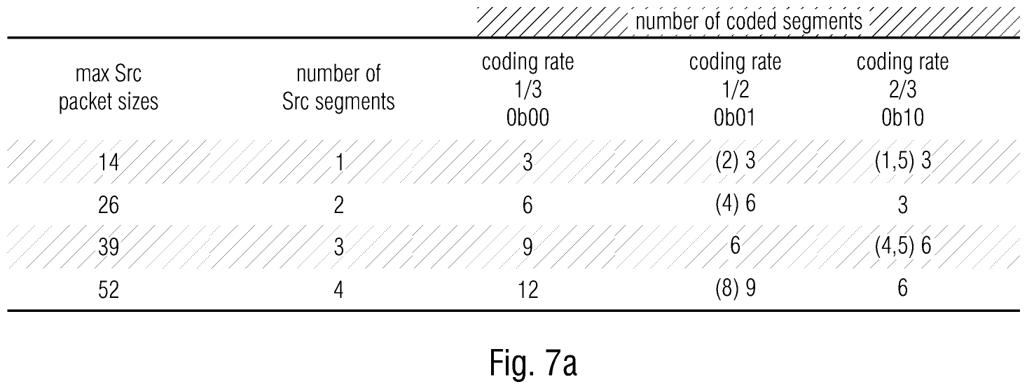

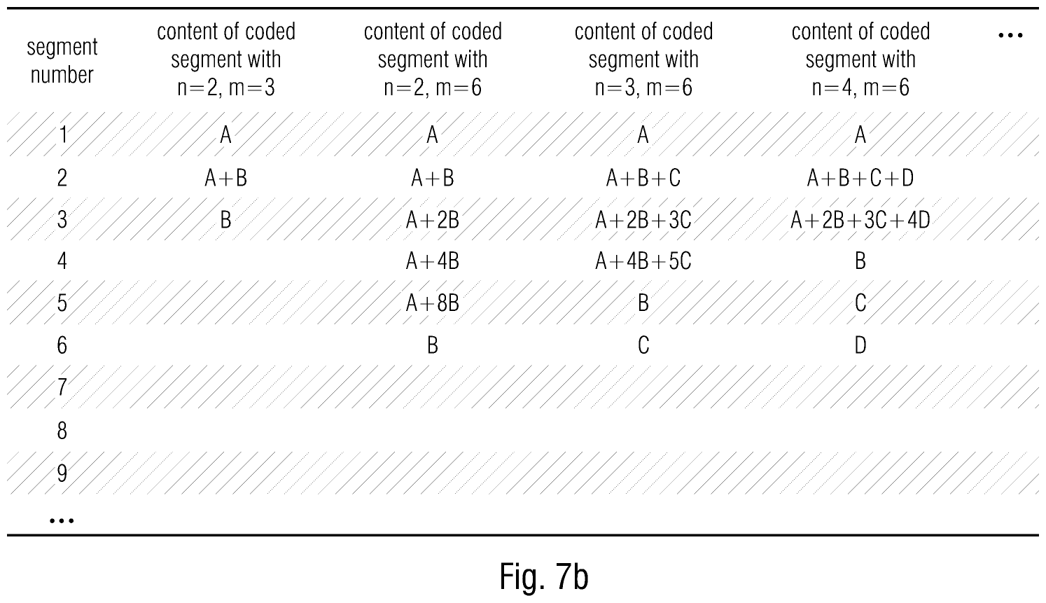

The number of segments can be calculated from this: n=rounding up (len/MaxBytesPerSegment). The number of m coded segments can be determined from the coding rate, either by calculation or using a table. In the calculation, the number of subcycles per cycle is considered and rounded up to the nearest multiple of the subcycles, for example. The variation with the table is shown in FIG. 7a, for example. For different maximum source packet sizes, the number of source segments is given as a function of the coding rate. If source packet len=14, this could be specially signaled and transmitted to a segment, otherwise 13 bits/byte would fit in each source segment. Another approach would of course also be possible according to embodiments.

From the number of source segments, the coding rule is defined as a list according to which the coded segments are formed. This list is transmitted, for example, before the actual transmission, wherein at least n coded segments are used for decoding at the receiver. Each additional coded segment transmitted improves reliability, as shown in FIG. 7b. A represents the first source segment, while B represents the second source segment. The content of the coded segment per segment number is indicated, for different cases, namely n=2 and m=3 or n=2 and m=6 or n=3 and m=6 or n=4 and m=6. It is to be noted at this point that FIG. 7b only shows examples of coding schemes. Based on this, linearly independent combinations are defined.

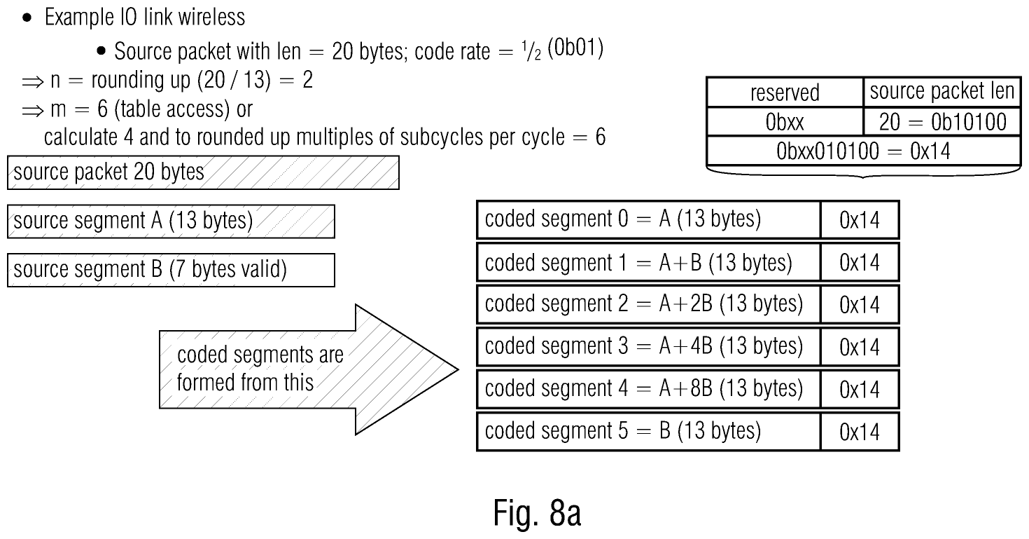

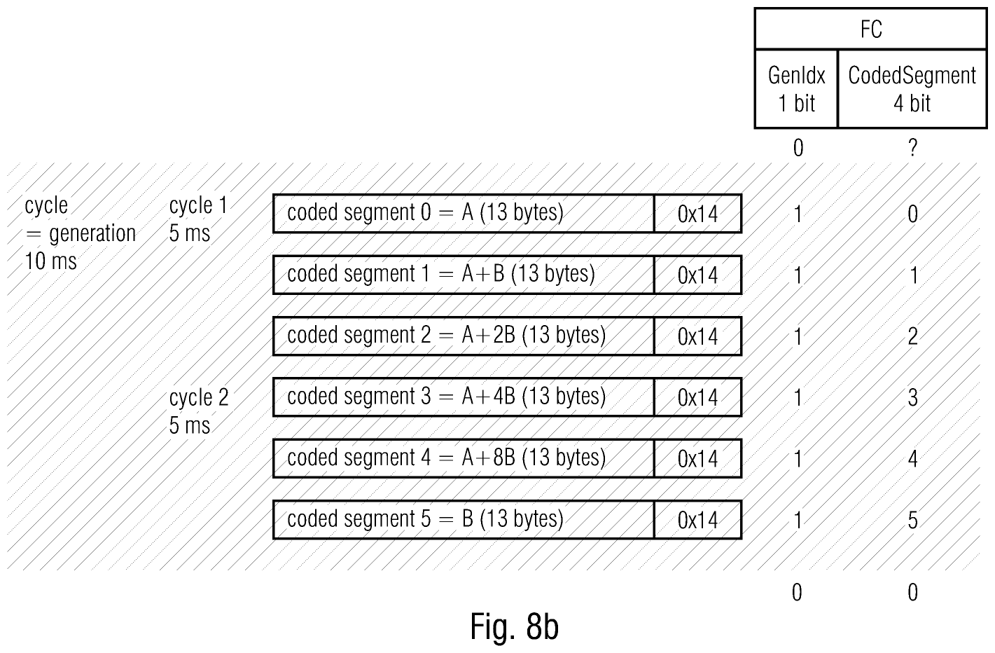

Based on a source packet with len=20 bytes/bit and a coding rate of 1/2 (0b01), this results in, rounded up, n=2 and m=6 via table access or, calculated, also 4 and rounded up to a multiple of subcycles per cycle=6. This can then be signaled as shown in FIG. 8a. FIG. 8a also shows the coded segments formed from this. The transfer of these to cycles 1 and 2 or the subcycles is shown in FIG. 8b.

As described above, successfully receiving n coded segments from k generated coded segments is sufficient. Signaling can be carried out as follows with IO link wireless: Generation ID identifies the coded segments belonging to the source packet. Coded segment identifies the segment number of the coded segments.

The flow control FC information is re-assigned in the control octet. The re-assignment is recognized by the fact that a new, previously reserved channel code ChC, for example 6, is present or by the fact that CRC32 is linked to the device ID by magic code, similar to the Final XOR mechanism in CRC32.

In the above embodiment, the entire concept was explained from the point of view of the transmitter. Further embodiments refer to a corresponding receiver. The receiver comprises a receive part, a decoding unit and a desegmenter, i.e. a reverse structure analogous to the transceiver 10 in FIG. 1a: receiver analogous to transmitter 16; decoder analogous to encoder 14 in FIG. 1a and desegmenter or combiner analogous to segmenter 12 in FIG. 1a.

Although some aspects have been described in connection with a device, it is understood that these aspects also represent a description of the corresponding method so that a block or a component of a device is also to be understood to be a corresponding method step or feature of a method step. In analogy, aspects described in connection with or as a method step also constitute a description of a corresponding block or detail or feature of a corresponding device. Some or all of the method steps may be performed by a hardware apparatus (or using a hardware apparatus), such as a microprocessor, a programmable computer or an electronic circuit. In some embodiments, some or more of the most important method steps may be performed by such an apparatus.

Depending on specific implementation requirements, embodiments of the invention may be implemented in hardware or in software. The implementation may be performed using a digital storage medium, for example a floppy disk, a DVD, a Blu-ray disc, a CD, ROM, PROM, EPROM, EEPROM or FLASH memory, a hard disk or any other magnetic or optical memory, on which electronically readable control signals are stored which can or do interact with a programmable computer system such that the respective method is performed. The digital storage medium can therefore be computer-readable.

Thus, some embodiments according to the invention comprise a data carrier having electronically readable control signals capable of interacting with a programmable computer system such that one of the methods described herein is performed.

In general, embodiments of the present invention may be implemented as a computer program product comprising a program code, wherein the program code is operative to perform one of the methods when the computer program product runs on a computer.

The program code can also be stored on a machine-readable medium, for example.

Other embodiments comprise the computer program for performing any of the methods described herein, wherein the computer program is stored on a machine-readable carrier. In other words, an embodiment of the method according to the invention is thus a computer program comprising program code for performing one of the methods described herein when the computer program runs on a computer.

Thus, a further embodiment of the methods according to the invention is a data carrier (or a digital storage medium or a computer-readable medium) on which the computer program for carrying out one of the methods described herein is recorded.

Thus, a further embodiment of the method according to the invention is a data stream or sequence of signals representing the computer program for performing one of the methods described herein. The data stream or sequence of signals may, for example, be configured to be transferred via a data communication link, for example via the Internet.

Another embodiment comprises a processing device, such as a computer or programmable logic device, configured or adapted to perform any of the methods described herein.

Another embodiment comprises a computer on which the computer program for performing one of the methods described herein is installed.

A further embodiment according to the invention comprises a device or system configured to transmit a computer program for performing at least one of the methods described herein to a receiver. The transmission may, for example, be electronic or optical. The receiver may be, for example, a computer, a mobile device, a storage device or a similar device. The device or system may include, for example, a file server for transmitting the computer program to the receiver.

In some embodiments, a programmable logic device (for example, a field programmable gate array, FPGA) may be used to perform some or all of the functionalities of the methods described herein. In some embodiments, a field programmable gate array may interact with a microprocessor to perform any of the methods described herein. In general, in some embodiments, the methods are performed by any hardware device. This may be general-purpose hardware such as a computer processor (CPU), or hardware specific to the method, such as an ASIC.

Further aspects and background knowledge are explained below.

Further embodiments of the present invention relate to a transceiver configured to transmit and/or receive frames with at least a first and a second cycle. According to embodiments, the transceiver may be an IO link wireless transceiver.

Embodiments provide a transceiver configured to transmit frames comprising a plurality of cycles with a deterministic cycle time (transmitting means, e.g., including decoding). The transceiver is configured to generate coded packets on the basis of n source segments, and to transfer (m) uncoded packets and the coded packets by means of the plurality of cycles, with an order of the uncoded and coded packets being selected such that a packet of the uncoded and/or coded packets to be transmitted last is reduced or at least not increased in terms of coding complexity, coding degree, coded content and/or coding rate when compared to a packet of the uncoded and/or coded packets to be transmitted before, wherein the transceiver is configured to transfer the n source segments by means of forward error correction. According to embodiments, the transceiver is configured to transfer the n source segments in the uncoded packets, e.g. after or before the transmission of the coded packets, i.e. at the beginning of the plurality of cycles (a packet can, for example, be a source segment (uncoded)). In this case, the transmission of the coded packets forms part of the forward error correction.

In the transmission order, for example, the coded packets are transferred first, while the uncoded or source packets (synonymous) are transmitted at the end.

Note: m indicates the number of available transmission processes. The coded and uncoded packets are transferred. Therefore, the sum of coded and uncoded packets is m.

This results in the following solution according to embodiments:
In wireless communication systems with a deterministic cycle time, Forward Error Correction (FEC) is used instead of ARQ according to embodiments.
By systematic coding, coded packets are generated from n source segments, wherein the coded packets form a linearly independent set, i.e. n coded packets are sufficient to decode the n source segments.
The transfer order of the coded packets is selected in accordance with embodiments such that the decoding effort after receiving the last coded segment is minimized, thus the delay time after receiving the last coded packet can be kept low.
The transmission of coded packets of higher degree (=number of source segments in a coded packet) takes place, e.g., at the beginning of the cycle, more complex decoding processes therefore take place at the beginning of the cycle.

According to embodiments, the forward error correction comprises at least a re-transmission of the coded packets in the one or more cycles of the plurality of cycles.

According to an embodiment, the transmission of the uncoded packets takes place at the end of one or more cycles of the plurality of cycles. For example, the transmission of the uncoded packets or pure source packets can take place at the beginning: e.g. for the column n=2, m=3, the order of transmissions is: A+B (coded), A (uncoded), B (uncoded). According to another embodiment, the transmission of the coded packets takes place at the end of the one or more cycles of the plurality of cycles. For example, the transmission of the uncoded packets or pure source packets can take place at the beginning. According to embodiments, either a coded or uncoded packet can be transmitted in one transmission process.

According to embodiments, the transmission of coded packets of a higher degree, in particular coded packets with a higher number of source segments in a coded packet, takes place at the beginning of one or more cycles of the plurality of cycles.

According to embodiments, the coded packets form a linearly independent set; the n coded packets may be sufficient to decode the n source segments.

According to embodiments, the plurality of cycles will each comprise at least a first and a second subcycle, which transmit at different frequencies.

According to embodiments, the first subcycle of a first cycle comprises a first uncoded packet and the second subcycle of the first cycle comprises a second uncoded packet or the first subcycle of the first cycle comprises a first packet portion and the second subcycle of the first cycle comprises a second packet portion.

In wireless communication systems with a deterministic cycle time whose cycles consist of subcycles for the transmission of a segment, FEC based on network coding is used instead of ARQ. Depending on the coding rate, the reliability improves, i.e. the packet loss rate decreases. Furthermore, the necessary number of cycles is reduced, i.e. the possible data rate increases.

According to embodiments, a combination of the first packet and the second packet may be transmitted in a third subcycle of a first cycle of the plurality of cycles and in a subcycle of the second cycle of the plurality of cycles as one or more of the coded packets.

According to embodiments, the plurality of cycles comprises a third subcycle; for example, a third uncoded packet may be transmitted in a third subcycle of the first and/or the second cycle of the plurality of cycles.

According to embodiments, the first, second and third packets are transmitted as one or more of the coded packets in subcycles of the second cycle.

According to embodiments, a fourth or further uncoded packet is transmitted in a first subcycle of a second cycle of the plurality of cycles.

According to embodiments, the first packet and the second packet and the third packet and the fourth or further packet are transmitted in the second and third subcycles of the second cycle as one or more of the coded packets.

These variations allow the data rate to be increased without any negative impact on reliability.

According to embodiments, the combination of the first and second packets and/or the combination of two packets as one or more of the coded packets is performed by means of network coding or by means of network coding with the aid of weighting factors.

According to embodiments, an area for control commands, in particular for channel code control commands, is provided in each cycle and/or in each subcycle, and signaling of the transmission of the first and second packet in the first subcycle and/or of the first and second coded packet in a subcycle is in the area for control commands, in particular an empty field in the area for control commands.

According to embodiments, the transmission of the first and second packets in the first subcycle and/or as one or more of the coded packets in a subcycle is signaled via a checksum, a CRC value and/or a CRC-32 value or via a checksum of a respective subcycle or of a range of a subcycle defined for a specific transmission; a checksum, a CRC value and/or a CRC-32 value is combined with an ID of the initial sender, for example by means of a logical function, in particular an XOR function.

According to embodiments, the transceiver is configured to activate flow control depending on the signaling in a standard mode or an extended mode for transmitting the first and second packets in the first subcycle and/or as one or more of the coded packets in a subcycle.

According to embodiments, the transceiver is configured to transmit each subcycle and/or each cycle at a different frequency according to a frequency hopping pattern.

According to embodiments, each subcycle comprises one or more downlink packets or multicast downlink packets; for example, each subcycle comprises one or more or a maximum of eight uplink packets.

According to embodiments, each cycle has a maximum length of 5 ms or a maximum length of 10 ms or a maximum length of 20 ms.

According to embodiments, the transceiver is configured for communication in accordance with the IO link standard or IO link wireless standard.

Embodiments provide a sensor and/or actuator node comprising a transceiver configured to transmit a first and a second packet and a combination of the first and second packets as an uplink in an uplink area of the respective subcycle allocated for the node.

Embodiments provide a master node comprising a transceiver configured to receive a first and second and combined first and second packet from the uplink and/or transmit a packet in the downlink.

Embodiments provide a method of operating a transceiver, comprising the following steps:
transmitting frames comprising a plurality of cycles with a deterministic cycle time,
generating coded packets on the basis of n source segments, and transferring uncoded packets and the coded packets by means of the plurality of cycles, wherein an order of the uncoded and coded packets is selected such that a packet of the uncoded and/or coded packets to be transmitted last is reduced or at least not increased in terms of coding complexity, coding degree, coded content and/or coding rate when compared to a packet of the uncoded and/or coded packets to be transmitted before,
transferring the n source segments using forward error correction.

According to embodiments, the plurality of cycles may each comprise at least a first and a second subcycle transmitted at different frequencies; alternatively/additively, the first subcycle comprises a first packet of the coded packet and the second subcycle comprises a second packet of the coded packets, or the first subcycle comprises a first packet portion and the second subcycle comprises a second packet portion.

The method may be computer-implemented.

The basic idea of this special implementation is applying network coding for IO link wireless or generally for communication systems with a deterministic cycle time:

In wireless communication systems with a deterministic cycle time whose cycles consist of subcycles for the transmission of a segment, forward error correction is of advantage instead of ARQ, but not necessarily based on network coding.

According to embodiments, the coding rate changes as follows:
reliability improves, i.e. the packet loss rate decreases.
the necessary number of cycles is reduced, i.e. the possible data rate increases.

Embodiments of the present invention, as already specified above, make use of precisely this approach.

It is to be noted at this point that IO link wireless is only an exemplary communication standard for which the invention is suitable, although the approach can of course also be transferred in other communication systems.

Further aspects, in particular with regard to signaling the new mode with the increased data rate and/or the increased reliability, are explained below.

Embodiments of the present invention operate a network with corresponding devices. Further embodiments relate to one or more corresponding devices, such as sensor nodes, which transmit their sensor data to a (central) master or generally to another device. Further embodiments refer to a corresponding master.

According to further embodiments, the sensor devices may also include actuators which receive control data from the master, for example. In this respect, further embodiments refer to an actuator as a device. Of course, sensor actuator applications are also conceivable.

Further embodiments relate to a corresponding method for operating a master, a sensor node or an actuator node or a sensor actuator node.

According to further embodiments, the invention may also be computer-implemented.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A transceiver configured to transmit at least one source packet in split and coded form, comprising:
a splitter configured to divide the at least one source packet into several source segments;
an encoder configured to encode the several source segments by coding rule in order to acquire coded segments;
a transmitter configured to transmit the coded segments as PHY packets by means of a plurality of cycles each comprising a plurality of subcycles, each subcycle comprising several slots;
wherein the coding rule specifies transfer of the plurality of source segments by means of forward error correction, and wherein the coding rule specifies an order such that a coding degree of the coded segments transmitted in the last PHY packet is reduced or reduced to coding degree 1.

2. The transceiver according to claim 1, wherein the coding rule specifies an order such that a coding degree of the coded segments transmitted in the first PHY packet is reduced or reduced to coding degree 1.

3. The transceiver according to claim 1, wherein, according to forward error correction, a source segment is comprised by at least two coded segments and/or at least two PHY packets; and/or
wherein any subset of the coded segments with at most n elements forms a linearly independent set, wherein n denotes the number of source segments; and/or
wherein the coding rule is in the form of a coding matrix, wherein the coding matrix specifies the coding degree 1 at least for the first and/or last coded segment; and/or
wherein any n×n submatrix of the coding matrix is invertible.

4. The transceiver according to claim 1, wherein a number k of n coded segments is sufficient for decoding the n source segments if the number k is at least equal to or greater than a number n of the source segments.

5. The transceiver according to claim 1, wherein the plurality of cycles each comprise at least a first and a second subcycle which are transmitted at different frequencies or simultaneously at different frequencies; and/or
wherein one or more PHY packets are transmitted per subcycle, or wherein one or more PHY packets are transmitted in different frequencies per subcycle.

6. The transceiver according to claim 5, wherein the different frequencies form a frequency hopping pattern over several cycles and/or per cycle and/or per subcycle; and/or
wherein the frequency hopping pattern is predefined.

7. The transceiver according to claim 1, wherein a PHY packet is transmitted over several slots or over several slots of equal frequency; and/or
wherein several PHY packets are transmitted in a subcycle; and/or
wherein, according to the coding rule, a first source segment of the several source segments is transmitted in the first subcycle of the first cycle and, according to the coding rule, a content of a second source segment of the several source segments is transmitted in the second subcycle of the first cycle.

8. The transceiver according to claim 7, wherein a combination of the first source segment and the second source segment in a second or subsequent third subcycle of a first cycle of the plurality of cycles or in a subcycle of the second cycle of the plurality of cycles is transmitted or re-transmitted as one or more of the coded segments; and/or
wherein the coding rule specifies a weighting factor.

9. The transceiver according to claim 1, wherein in each cycle and/or in each subcycle an area for control commands, in particular for channel code control commands, is provided, and wherein signaling of the transmission of the first and second of the coded segments in the first subcycle and/or of the first and second of the coded segments in a subcycle is in the area for control commands, in particular an empty field, in the area for control commands.

10. The transceiver according to claim 1, wherein the signaling of the transmission of the first and second of the coded segments in the first subcycle and/or of the first and second coded segments in a subcycle is performed via a checksum, a CRC value and/or a CRC-32 value, or the signaling of the transmission of the first and second of the coded segments in the first subcycle and/or of the first and second coded segments is performed via a checksum of a respective subcycle or of an area of a subcycle defined for a specific transmission; and/or
wherein a checksum, a CRC value and/or a CRC-32 value is combined with an ID of the initial transmitter by means of a logical function, in particular an XOR function.

11. The transceiver according to claim 10, wherein the transceiver is configured to activate a flow control depending on the signaling in a standard mode or an extended mode for transmitting the coded segments; and/or
wherein the transceiver is configured to transmit each subcycle and/or each cycle at a different frequency according to a frequency hopping pattern; and/or
wherein one or more downlink packets or multicast downlink packets are transmitted in each subcycle; and/or
wherein one or more or a maximum of eight uplink packets are transmitted in each subcycle.

12. A sensor and/or actuator node comprising a transceiver according to claim 1, configured to transmit coded segments as an uplink in an uplink area of the respective subcycle assigned to the node.

13. A master node comprising a transceiver according to claim 1, configured to receive coded segments from the uplink and/or to transmit a packet in downlink.

14. A further transceiver configured to receive at least one source packet which is split and coded, comprising:
a receiver configured to receive several PHY packets, each PHY packet comprising a coded segment and being transmitted by means of a plurality of cycles each comprising a plurality of subcycles, each subcycle comprising several slots;
a decoder configured to decode the coded segments in order to acquire source segments;
a combiner configured to assemble the source segments to form at least one source packet;
wherein the decoder is configured to perform decoding as soon as a number k of coded segments has been received, wherein the number k corresponds to at least a number n of the source segments.

15. The further transceiver according to claim 14, wherein the decoder uses a coding matrix and/or submatrices derivable from the coding matrix for decoding; and/or
wherein the decoder is configured to retain a coding matrix or submatrices for decoding; and/or
wherein the decoder is configured to calculate and retain inverse matrices or submatrices for each receive case; and/or
wherein the decoder is configured to systematically reduce or reduce a number of inverse matrices or submatrices to be used and to be retained; or
wherein the decoder is configured to systematically reduce a number of inverse matrices or submatrices to be used and to be retained as the number of received and/or non-received PHY packets increases.

16. The further transceiver according to claim 15, wherein reducing is performed by excluding from the inverse matrices or submatrices associated with a certain PHY packet if the certain PHY packet is not received, or by using the inverse matrices or submatrices associated with a certain PHY packet if the particular PHY packet is received.

17. The further transceiver according to claim 14, wherein the decoder is configured to perform partial decoding based on already received coded packets using the retained and/or retained inverse matrices or reduced partial matrices; and/or
wherein reducing and/or partial decoding is performed stepwise during reception depending on the received and non-received coded packets.

18. A method of operating a transceiver according to claim 1, comprising:
transmitting, in a split and coded form, at least one source packet, comprising the following substeps:
dividing the at least one source packet into a plurality of source segments;
encoding the plurality of source segments by coding rule to acquire coded segments;
transmitting the coded segments as PHY packets by means of several cycles each comprising several subcycles, each subcycle comprising several slots;
wherein the coding rule specifies transferring the plurality of source segments by means of forward error correction, and wherein the coding rule specifies an order such that a coding degree of the coded segments transmitted in the last PHY packet is reduced or reduced to coding degree 1.

19. A method of operating a transceiver according to claim 14, comprising:
receiving several PHY packets, each PHY packet comprising a coded segment and being transmitted by means of a plurality of cycles each comprising a plurality of subcycles, each subcycle comprising several slots;
decoding the coded segments to acquire source segments;
assembling the source segments to form at least one source packet;
wherein decoding takes place as soon as a number k of coded segments has been received, wherein the number k corresponds to at least a number n of the source segments.

20. A non-transitory digital storage medium having a computer program stored thereon to perform a method of operating a transceiver according to claim 1, comprising:
transmitting, in a split and coded form, at least one source packet, comprising the following substeps:
dividing the at least one source packet into a plurality of source segments;
encoding the plurality of source segments by coding rule to acquire coded segments;
transmitting the coded segments as PHY packets by means of several cycles each comprising several subcycles, each subcycle comprising several slots;
wherein the coding rule specifies transferring the plurality of source segments by means of forward error correction, and wherein the coding rule specifies an order such that a coding degree of the coded segments transmitted in the last PHY packet is reduced or reduced to coding degree 1,
when the computer program is run by a computer.

21. A non-transitory digital storage medium having a computer program stored thereon to perform a method of operating a transceiver according to claim 14, comprising:
receiving several PHY packets, each PHY packet comprising a coded segment and being transmitted by means of a plurality of cycles each comprising a plurality of subcycles, each subcycle comprising several slots;
decoding the coded segments to acquire source segments;
assembling the source segments to form at least one source packet;
wherein decoding takes place as soon as a number k of coded segments has been received, wherein the number k corresponds to at least a number n of the source segments,
when the computer program is run by a computer.
